(19) United States
(12) Patent Application Publication
(10) Pub. No.: US 2009/0257924 A1
(43) Pub. Date: Oct. 15, 2009

(54) Device for the reduction of nitrogen oxides in the exhaust gas of internal combustion engines

(75) Inventors: Heinrich Dismon, Gangelt (DE); Andreas Köster, Essen (DE); Rolf Lappan, Köln (DE); Martin Nowak, Düsseldorf (DE); Werner Müller, Kaiserslautern (DE)

Correspondence Address: GRIFFIN & SZIPL, PC, SUITE PH-1, 2300 NINTH STREET, SOUTH, ARLINGTON, VA, 22204, US

(73) Assignees: PIERBURG GMBH, Neuss (DE); TECHNISCHE UNIVERSITÄT KAISERSLAUTERN, Kaiserslautern (DE)

(21) Appl. No.: 12/162,454

(22) PCT Filed: Jan. 26, 2007
(86) PCT No.: PCT/EP2007/050786

§ 371 Date: Nov. 4, 2008

(30) Foreign Application Priority Data
Jan. 27, 2006 (DE) 10 2006 004 170.4

(51) Int. Cl. B01D 53/56

(52) U.S. Cl. 422/174; 422/173

(57) ABSTRACT

A device for the reduction of nitrogen oxides in the exhaust gas of internal combustion engines has a thermolysis reactor (10). In the thermolysis reactor (10), urea is converted into ammonia and isocyanic acid by means of the supply of heat. In a preferred embodiment of the invention, the thermolysis reactor (10) is arranged within the exhaust gas duct (26) and is thermally coupled to an oxidation catalytic converter (30) which is connected upstream of the thermolysis reactor (10) in the flow direction. As a result of the exothermic reactions taking place in the oxidation catalytic converter (30), it is possible for heating of the thermolysis reactor (10) to take place. In order to further increase the temperature, it is possible for fuel to be injected into the oxidation reactor (30) by means of a fuel supply device. The fuel is burned catalytically in the oxidation catalytic converter (30).

This is a National Phase Application in the United States of International Patent Application No. PCT/EP2007/050786 filed Jan. 26, 2007, which claims priority on German Patent Application No. DE 10 2006 004 170.4, filed Jan. 27, 2006. The entire disclosures of the above patent applications are hereby incorporated by reference.

### TECHNICAL FIELD

The invention refers to a device for the reduction of nitrogen oxides in the exhaust gas of internal combustion engines. The device is particularly suited for use in motor vehicles, especially motor vehicles with a diesel engine.

### BACKGROUND OF THE INVENTION

EP 1 338 562 describes a method and a device for producing ammonia. Dry urea is decomposed in an electrically heated reactor into ammonia and isocyanic acid. For the hydrolysis of isocyanic acid to ammonia, a hydrolysis catalytic converter is arranged downstream of the reactor. The thermolysis reactor and the hydrolysis reactor are integrated in a single unit. The water required for hydrolysis is fed to the hydrolysis catalytic converter in a relatively limited exhaust gas flow. The partial exhaust gas flow is branched from the exhaust gas flow and has to be limited such that a sufficient volume of water is available for hydrolysis in all operating conditions of the internal combustion engine. Additional exhaust gas volumes would cause a cooling of the thermolysis reactor or require additional heating power. In order to be able to supply the hydrolysis reactor with a corresponding exhaust gas volume in the different operating ranges of the internal combustion engine, it is advantageous to provide a controllable valve in the branch line through which partial exhaust gas flow flows. Further, it is necessary to adapt the partial exhaust gas flow for the internal combustion engine to all stationary and non-stationary driving conditions. This causes a substantial application effort. With too small a partial exhaust gas flow, deposits are formed in the short term in the line leading from the reactor to the exhaust gas channel and through which the ammonia and other reaction products are fed to the exhaust gas.

Further, the device described in EP 1 338 562 has the shortcoming of a corresponding structural space being required in the engine compartment. Moreover, this device requires a special hydrolysis catalytic converter that has to be connected immediately downstream of the thermolysis reactor. The effect of the above shortcomings of the reactor described in EP 1 338 562 is that such a reactor is expensive.

Further, devices for producing ammonia from liquid urea are known. However, these have principle-related drawbacks, so that a reliable reduction of nitrogen oxides in the exhaust gas is impeded. One of the drawbacks of liquid urea systems is, for example, that the aqueous urea solution freezes at outside temperatures below approx. −11° C. so that the system has to be heated before start-up. This increases the system costs and can impair the functioning of the system. This problem does not exist in solid urea systems. Further, a solid urea system has improved cold-start properties with respect to a liquid urea system. The reason for this is that the thermolysis of the urea takes place in a separately heated thermolysis reactor. The same can reach the minimum temperature required for a complete thermolysis of the urea earlier.

Moreover, liquid urea systems cannot meet the demands with respect to weight and required space. To produce a comparable volume of ammonia, solid urea, e.g. in the form of small spheres, only requires about one third of the storage volume and also about a third of the storage mass, as compared with an aqueous urea solution. This is of great importance for the structural space required in the vehicle and for the additional weight or for the distance travelled with one fill of urea.

Further disadvantages stem from the corrosive behaviour of an aqueous urea solution towards some materials as well as from the instability of the aqueous urea solution, which tends to partial crystallization after some months, so that the system functionality is impaired. For the reasons mentioned, the use of solid urea systems is principally preferred over the use of liquid urea systems.

### BRIEF SUMMARY OF THE INVENTION

It is an object of the invention to provide a simpler and more economic structure of a device for reducing nitrogen oxides in the exhaust gas of internal combustion engines, especially internal combustion engines of vehicles.

The device of the invention for the reduction of nitrogen oxides comprises a thermolysis reactor for producing ammonia from solid urea, in which ammonia is obtained from a solid, ammonia-producing substance through the supply of heat. The substance is urea in solid form. However, other suited solids can be used. In particular, the solid urea is in the form of pellets or small spheres and is supplied to the thermolysis reactor in doses or separately. A corresponding metering device is described in DE 102 51 498. According to the invention, the use of solid urea or other suited solid substances is provided, since the storage thereof in a corresponding storage container is simpler and safer. A heating means is connected with the thermolysis reactor for heating a thermolysis chamber in the thermolysis reactor.

It is an essential aspect of the invention that the thermolysis reactor is arranged in and/or at the exhaust gas channel. In one embodiment, the thermolysis reactor is thus arranged immediately adjacent the exhaust gas channel. This is advantageous in that the temperature of exhaust gas is used to heat the thermolysis reactor. In another embodiment, the theremolysis reactor may partly project into the exhaust gas channel. In a particularly preferred embodiment, the thermolysis reactor is completely arranged in the exhaust gas channel. This is advantageous in that the required power of the heating means can be reduced since the heating means only has to be an auxiliary heating means for taking the thermolysis reactor to the operating temperature, preferably in all operating conditions of the internal combustion engine.

When ammonia is produced from urea, a by-product is isocyanic acid. This can be converted into ammonia by hydrolysis. According to the invention, the thermolysis reactor is thus arranged upstream of the catalytic converter provided in the exhaust gas channel for the reduction of nitrogen. The catalytic converter is an SCR catalytic converter, in particular. The ammonia leaving the thermolysis reactor and the possible additional further reaction products produced, especially the isocyanic acid thus enter the SCR catalytic converter together with the exhaust gas. Since the exhaust gas always supplies a sufficient volume of water to the SCR catalytic converter, the isocyanic acid is hydrolysed into ammonia in the SCR catalytic converter. According to the invention, the SCR catalytic converter is also used as a hydrolysis reactor. No separate hydrolysis catalytic converter connected downstream of the thermolysis reactor is required. The thermolysis products can be introduced directly into the exhaust gas.

The fact that no hydrolysis catalytic converter is arranged downstream of the thermolysis reactor allows the thermolysis reactor to be placed in a simple manner in the immediate vicinity of the exhaust gas channel or even within the exhaust gas channel. Known thermolysis reactors with an integrated hydrolysis reactor are not suited for such an arrangement.

It is particularly preferred to insert the thermolysis reactor into the exhaust pipe through a bore, into which it protrudes at least partly. This arrangement serves to mix the thermolysis products with the exhaust gas flow as effectively as possible. Here, the engine exhaust gas itself has temperatures in wide operation ranges that are far below the temperature level within the thermolysis reactor. Consequently, in the turbulent exhaust gas flow, an intensive heat transport takes place from the thermolysis reactor into the exhaust gas, which transport does not exist when the thermolysis reactor is arranged externally, for example, in the engine compartment. Therefore, a forced cooling of certain portions of the thermolysis reactor by the passing exhaust gas occurs, so that the thermal requirements with respect to a safe thermolysis are not always fulfilled. A particular problem in this context is a continued chemical reaction of the isocyanic acid produced in thermolysis, which occurs especially when parts of the inner space of the thermolysis reactor are cooled to temperatures below 350-400° C. To avoid such cooling, it is therefore necessary to provide a specially adapted design of the electric heating and of the distribution of the heating power in different zones of the thermolysis reactor. For example, the heating means in the thermolysis reactor can provide more heating power at places that are cooled more by the exhaust gas.

It is another advantage of the present device that the thermolysis reactor can be arranged immediately at and/or in the exhaust gas channel. Thus, no corresponding space is required in the engine compartment. Possibly, the thermolysis reactor can also be arranged in a bypass line of the exhaust gas channel.

Branching an exact partial exhaust gas flow from the exhaust gas channel in order to feed it to a hydrolysis reactor, as described in EP 1 338 562, is not required according to the invention. A corresponding controllable valve for regulating the partial exhaust gas flow as a function of corresponding operating conditions is thus not required either.

Therefore, the device of the present invention is of simple structure and readily fitted to internal combustion engines. Accordingly, it is an economic device for the thermal treatment of ammonia-producing substances, especially urea.

Preferably, the heating means is an electric heating means. This is advantageous in that the heating means can be controlled in a simple manner. This allows to exactly adjust the required temperature in the thermolysis chamber and to thus guarantee a temperature required for thermolysis in the different operating states.

In a preferred embodiment, the thermolysis reactor is arranged downstream of an oxidation catalytic converter, seen in the flow direction of the exhaust gas. Thus, the thermolysis reactor is arranged between the oxidation catalytic converter and the SCR catalytic converter. Substantially, an exothermal oxidation of non-combusted hydrocarbons and carbon monoxide occurs in the oxidation catalytic converter. Arranging the thermolysis reactor downstream of the oxidation catalytic converter, seen in the flow direction, therefore offers the advantage that the heat generated in the oxidation catalytic converter can be used to heat the thermolysis reactor. Preferably, the thermolysis reactor is therefore placed in the immediate vicinity of the oxidation catalytic converter. Here, it is particularly preferred if the thermolysis reactor is thermally coupled to the oxidation catalytic converter. In particular, the thermolysis reactor abuts against the oxidation catalytic converter. Preferably, a heating surface of the thermolysis reactor contacts the oxidation catalytic converter.

In a further preferred embodiment of the invention, the thermolysis reactor is at least partly arranged in the oxidation catalytic converter. The oxidation catalytic converter is of annular shape, at least in the area of the thermolysis reactor, and thus preferably surrounds the thermolysis reactor along its circumference. Here, the heating surface of the theremolysis reactor is substantially perpendicular to the flow direction of the exhaust gas in order to guarantee a good heating of the thermolysis reactor.

In the embodiment of the invention, where the thermolysis reactor is heated by the heat produced in the oxidation catalytic converter, an additional heating means could be omitted. In particular, the heating means, which preferably is an electric heating means, could be more compact. This contributes to further cost saving.

In addition to an electric heating means, it is possible to feed fuel to the oxidation catalytic converter through a fuel supply means. This takes place in the oxidation catalytic converter and increases the temperature available for heating the thermolysis reactor. In particular, the fuel supply is effected by means of an injection nozzle, preferably arranged upstream of the oxidation catalytic converter, seen in the flow direction. Through an injection nozzle, fuel can be supplied to the oxidation catalytic converter in a purposeful manner. Preferably, the fuel supply line includes a controllable valve so that the volume of fuel supplied can be controlled. The fuel supply can thus be controlled in dependence on the temperature prevailing in the thermolysis chamber.

Preferably, the fuel supply only takes place in a portion of the oxidation catalytic converter. Preferably, this is the portion of the oxidation catalytic converter immediately adjacent the thermolysis reactor. This is advantageous in that the fuel supplied is used substantially entirely for heating the thermolysis reactor.

It is particularly preferred for the oxidation catalytic converter to have an extra coating in this portion, so as to facilitate combustion, particularly catalytic combustion.

Since, according to the invention, the hydrolysis of the isocyanic acid occurs in the SCR catalytic converter, it is advantageous to preferably distribute the reaction products from the thermolysis reactor as uniformly as possible. To this end, a mixer may be provided between the thermolysis reactor and the SCR catalytic converter. This ensures that all reaction products produced in the thermolysis reactor are distributed substantially uniformly over the inlet surface of the SCR catalytic converter. Thereby, it is guaranteed that the largest part possible of the nitrogen oxides in the exhaust gas are reduced in the SCR catalytic converter.

The following is a detailed description of the invention with reference to preferred embodiments illustrated in the accompanying drawings.

### BRIEF DESCRIPTION OF THE DRAWING(S)

In the Figures:

FIG. 1 is a schematic illustration of a thermolysis reactor,

FIG. 2 is a schematic illustration of a first embodiment of a device according to the invention,

FIG. 3 is a schematic illustration of a second embodiment of a device according to the invention, und

FIG. 4 is a schematic illustration of a third embodiment of a device according to the invention.

### DETAILED DESCRIPTION OF THE INVENTION

In a preferred embodiment, a thermolysis reactor 10 comprises a housing 12 that is generally cup-shaped and thus open to one side 14. A heatable element 16 is arranged within the housing. This may be, for example, a body of heat-resistant material with a plurality of channels 18. In particular, the heatable element 16 may comprise metal or ceramics and may possibly be coated therewith. The heatable elements 16 may be heated by means of an electric heating means 17.

A thermolysis chamber 20 is provided within the housing 12 and especially also within the heatable element 16. Via a feed line 22, the thermolysis chamber may be fed with substances for producing ammonia. Preferably, the substance fed is urea. The urea is present in solid form as pellets or small spheres 24. The small spheres 24 are heated in the thermolysis chamber 20. This produces ammonia and isocyanic acid as reaction products. These reaction products flow through the channels 18 and out from the side 14 of the thermolysis reactor in the direction of the arrows 25.

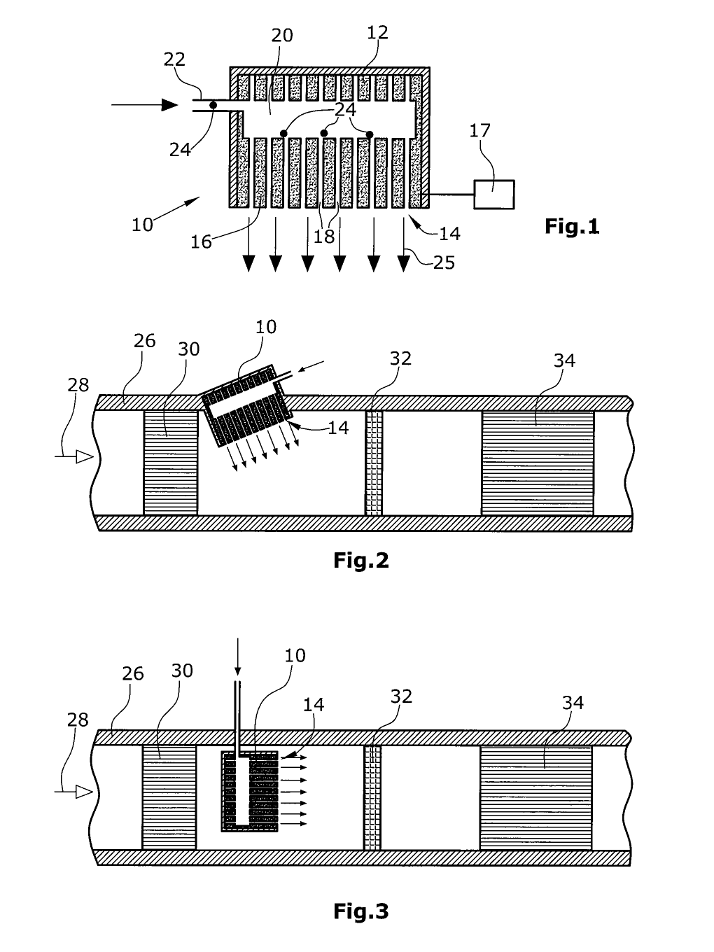

In a first preferred embodiment of the invention (FIG. 2), the thermolysis reactor 10, which in particular is a thermolysis reactor designed according to FIG. 1, is arranged at an exhaust gas channel 26. In the embodiment illustrated in FIG. 2, the thermolysis reactor 10 partly protrudes into the exhaust gas channel 26, the open side 14 of the thermolysis reactor 10 being directed into the channel 26.

Upstream of the thermolysis reactor 10, seen in the flow direction 28, an oxidation catalytic converter 30 is arranged Thus, the exhaust gas flows through the oxidation catalytic converter 30, where oxidation takes place. The oxidation catalytic converter serves to oxidize hydrocarbons and CO as well as to form NO₂ for increasing the low-temperature activity of the SCR catalytic converter. A heating means, especially an electric heating means, connected with the heatable elements 16 (FIG. 1), can be less powerful, whereby costs can be cut. The exhaust gas flows along the thermolysis reactor 10 and heats the same.

To keep the temperature in the thermolysis chamber 20 as constant as possible, the electric heating means 17 is controllable. This is advantageous especially because of the different exhaust gas temperatures occurring as a function of the various operating states.

Downstream of the thermolysis reactor 10, seen in the flow direction 28, a mixer 32 is provided in the exhaust gas channel 26. The mixer mixes the exhaust gas flow so that ammonia coming from the thermolysis reactor 10, as well as the isocyanic acid therefrom are uniformly distributed in the exhaust gas flow. This has the advantage of a substantially homogeneous mixture flowing into a SCR catalytic converter 34 arranged downstream of the mixer 32 in the flow direction 28. This ensures a good reduction of nitrogen oxides in the exhaust gas.

In a second preferred embodiment (FIG. 3), the same or similar components are identified by the same reference numerals. The embodiment illustrated in FIG. 3 differs from the embodiment illustrated in FIG. 2 only in that the thermolysis reactor 10 is arranged completely inside the exhaust gas channel 26. Here, as illustrated, the thermolysis reactor 10 may be located centrally in the exhaust gas channel 26, but it may as well be situated at the edge of the exhaust gas channel 26. The thermolysis reactor 10 is held in the exhaust gas channel 26, e.g., by webs or it I directly connected with a wall of the exhaust gas channel 26.

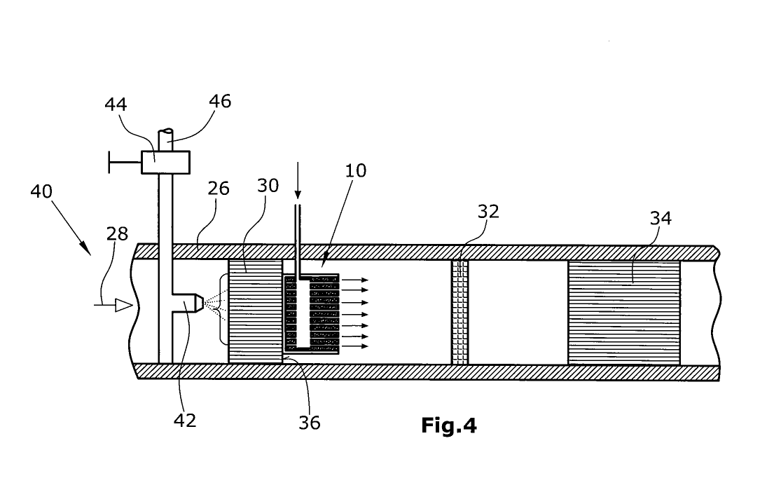

In a third preferred embodiment (FIG. 4), the same and similar components are again identified by the same reference numerals. The particularity of this embodiment is that the thermolysis reactor 10 abuts an outer side 36 of the oxidation catalytic converter 30. Thus, a heating surface 38, which may be a part of the housing 12 (FIG. 1), rests on the outer side 36. This ensures a good transfer of the heat produced in the oxidation catalytic converter 30 to the thermolysis reactor 10.

Preferably, a fuel supply means 40 is provided upstream of the oxidation catalytic converter 30, seen in the flow direction 28. The fuel supply means 40 comprises an injection nozzle 42. Through the injection nozzle 42, fuel can be injected into the oxidation catalytic converter 30. This leads to a catalytic combustion of the fuel in the oxidation catalytic converter 30.

For the control of the fuel volume supplied to the oxidation catalytic converter 30, the fuel supply means further comprises a valve 44, especially a controllable valve. The fuel line 46 of the fuel supply means 40 may be connected directly with the fuel tank.

Preferably, the fuel is injected only into a portion 48 of the oxidation catalytic converter 30. This portion 48 is the region of the oxidation catalytic converter 30 immediately upstream of the thermolysis reactor 10, seen in the flow direction 28. Thus, the heat is produced in a region, particularly a cylindrical region, of the oxidation catalytic converter 30 that extends in the flow direction 28 and adjoins the heating surface 38. Thereby, it is avoided to produce additional heat in parts of the oxidation catalytic converter 30, which heat can not be used in heating the thermolysis reactor 10.

The injection of the fuel into the oxidation catalytic converter suitably occurs only from a catalytic converter temperature above 180°, since activity only starts form this temperature when conventional fuel is injected.

1. A device for reduction of nitrogen oxides in an exhaust gas of an internal combustion engine, comprising:
an exhaust gas channel;
a thermolysis reactor operative to produce ammonia from solid urea, arranged in the exhaust gas channel;
a thermolysis chamber;
a heater thermally coupled to the thermolysis reactor, operative to heat the thermolysis chamber; and
an SCR catalytic converter, disposed downstream of the thermolysis reactor in the exhaust gas channel in a flow direction of the exhaust gas, through which the ammonia flows; and
wherein the SCR catalytic converter is operative as a hydrolysis catalytic converter.

2. The device of claim 1, wherein the heater is configured as an electric heater.

3. The device of claim 1, further comprising an oxidation catalytic converter arranged upstream of the thermolysis reactor.

4. The device of claim 3, wherein the thermolysis reactor is disposed so that the thermolysis reactor is heated by reaction heat produced in the oxidation catalytic converter.

5. The device of claim 3, wherein the thermolysis reactor is thermally coupled with the oxidation catalytic converter.

6. The device of claim 3, wherein the thermolysis reactor is arranged at least partly in the oxidation catalytic converter.

7. The device of claim 1, wherein the thermolysis reactor comprises a heating surface substantially perpendicular to the flow direction of the exhaust gas flow.

8. The device of claim 3, wherein the heater comprises a fuel supply for the oxidation catalytic converter.

9. The device of claim 8, wherein the fuel supply comprises an injection nozzle disposed upstream of the oxidation catalytic converter.

10. The device of claim 8, operative to supply fuel only into a portion of the oxidation catalytic converter.

11. The device of claim 10, wherein the oxidation catalytic converter has an additional coating in said portion.

12. The device of claim 1, wherein a mixer is provided between the thermolysis reactor and the SCR catalytic converter.

13. The device of claim 2, further comprising an oxidation catalytic converter arranged upstream of the thermolysis reactor.

14. The device of claim 13, wherein the thermolysis reactor is arranged at least partly in the oxidation catalytic converter.

15. The device of claim 14, additionally comprising a fuel supply for the oxidation catalytic converter.

16. The device of claim 13, additionally comprising a mixer disposed between the thermolysis reactor and the SCR catalytic converter,
wherein the thermolysis reactor is arranged at least partly in and thermally coupled with the oxidation catalytic converter;
wherein the thermolysis reactor comprises a heating surface substantially perpendicular to the flow direction of the exhaust gas flow; and
wherein the heater comprises an injection nozzle operative to inject fuel into the oxidation catalytic converter.

17. The device of claim 16, wherein the fuel supply is operative to supply fuel only into a portion of the oxidation catalytic converter, and wherein this portion has an additional coating operative to facilitate catalytic combustion.

18. The device of claim 9, operative to supply fuel only into a portion of the oxidation catalytic converter.

19. The device of claim 18, wherein the oxidation catalytic converter has an additional coating in said portion.
